(19) United States
(12) Patent Application Publication
(10) Pub. No.: US 2004/0234329 A1
(43) Pub. Date: Nov. 25, 2004

(54) LOOSE LEAF BINDER

(76) Inventor: Robert Ludvik Blumenblatt, New York, NY (US)

Correspondence Address: DARA L ONOFRIO, ONOFRIO LAW, 1133 BROADWAY, SUITE 1600, NEW YORK, NY, 10010, US

(21) Appl. No.: 10/443,624

(22) Filed: May 22, 2003

(51) Int. Cl. B42F 13/00

(52) U.S. Cl. 402/73

(57) ABSTRACT

A front and back cover of a binder are separate from one another to be attached to and bind a document. Each cover is in a form of a pocket having a spine edge opening to accept extensions of a spine cover. The spine cover is dimensioned to adapt to the thickness of the document being bound. Each front and back cover has an inside flap with openings that permit flexible prong paper fasteners to extend through these openings and through the document thereby holding each cover to the document.

### BACKGROUND OF THE INVENTION

This invention relates to a loose leaf binder and more particularly to a binder with variable holding capacity. The binder provides the ability to neatly encompass a document of any desired thickness and to engage a spine that labels the document in a fashion that minimizes use of shelf space.

A wide variety of document covers are known in the art to protect multi-page documents and enable the labeling of these documents.

What Applicant has found is that nothing provides the combined function of: (a) front and back covers which can be attached to one another at any desired distance so as to efficiently encompass any desired document thickness within the range provided by the fastening together with (b) a handy method of labeling the document along the spine. These two functions are required in order to shelve various thickness documents on their edge in a row with spine labels that appropriately identify each document.

Accordingly, a major purpose of this invention is to provide a loose leaf binder which will combine the above two functions.

It is an inherent object of this invention to provide a single cover design for achieving the above objects.

It is a further object of this invention to provide a loose leaf binder design which is both inexpensive and easy to use so that it will be cost and time effective in providing the above objects.

Secondary purposes of this invention include providing a loose leaf binder design which is capable of providing a bound product which simulates the appearance of a paperback or soft cover book.

A purpose of this invention is to provide a design which enables the use of standard prong paper fasteners. This provides an end use bound product that is expandable to whatever thickness is required by the material to be bound yet avoids the waste of shelf space that occurs when the capacity of standard binders is only partly used.

### Brief Description

In brief, a preferred embodiment of this invention employs a first and second cover which are structurally identical so that either one can serve as the front cover and the other as the back cover.

On the spine end of each cover, there is a flap which folds inwardly and has openings to accept connecting prongs of a flexible prong paper fastener. The two covers are not connected to one another and are only fastened to the front and back of a document by these prongs which pass through the document and through each of these flaps.

On the outer surface of each cover, there is a transparent pocket that has a pocket opening at the spine end. When the front and back covers are assembled on and fastened to a document, a spine cover can be laid across the spine and tucked into the open edges of the front and back cover pockets. This spine cover provides document labeling and is held in place by the pockets of the two covers. The spine cover can be removed and relabeled or additional labeling provided and reinserted into the two envelope pockets.

### BRIEF DESCRIPTION OF THE DRAWINGS

FIG. 1 is a top view of the device of this invention with the two covers 10, 12 displayed out and a document 14 connected to the covers by flaps 16. The spine element 18 is also shown.

FIG. 2 is an exploded view similar to that of FIG. 1.

FIG. 2A is a view along the plane 2A-2A of FIG. 2.

It shows the heat sealing of the sheets 28 and 30 at their edges to form the pocket 26.

FIG. 3 is a plan view of the cover 10 or 12.

FIG. 4 is a cross-section along the plane 4-4 of FIG. 3 except that FIG. 4 shows the flap 16 in an extended position rather than the normal forward position shown in FIG. 3.

FIG. 5 is a sectional view along the plane 5-5 of FIG. 1 illustrating the spine insertion into the pocket of the cover 10.

FIG. 6 is a perspective view, without the document, showing the relationship between the two covers 10 and 12 with their flap 16 and showing the spine sheet partly inserted in the pockets of the covers.

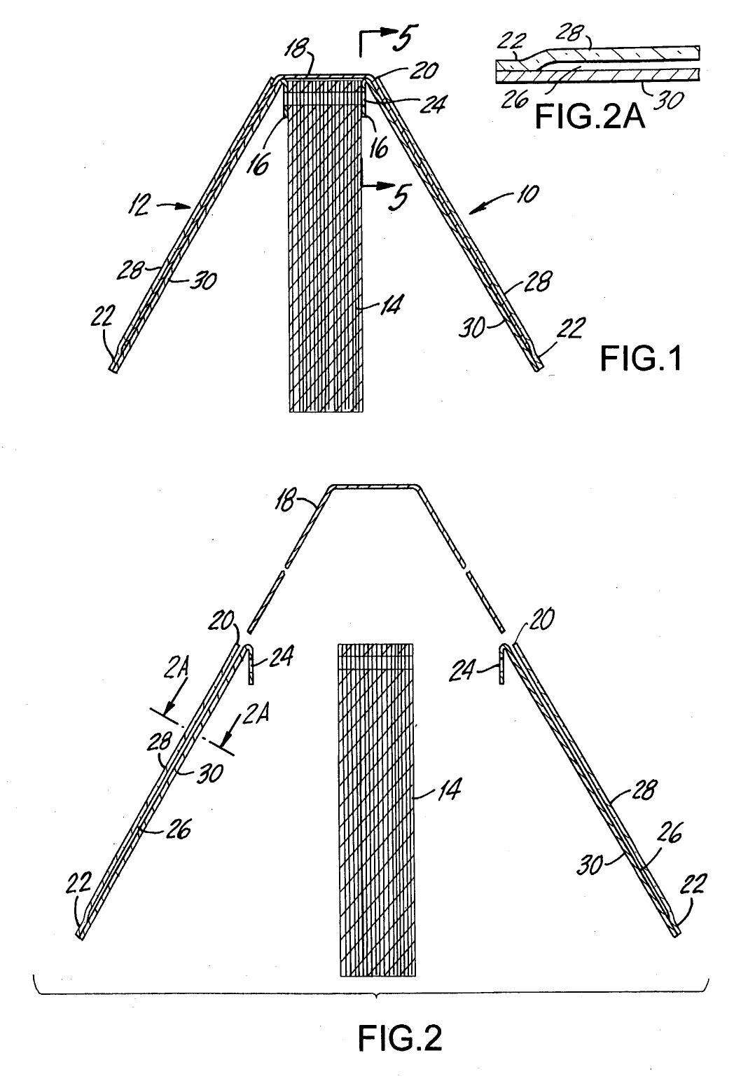

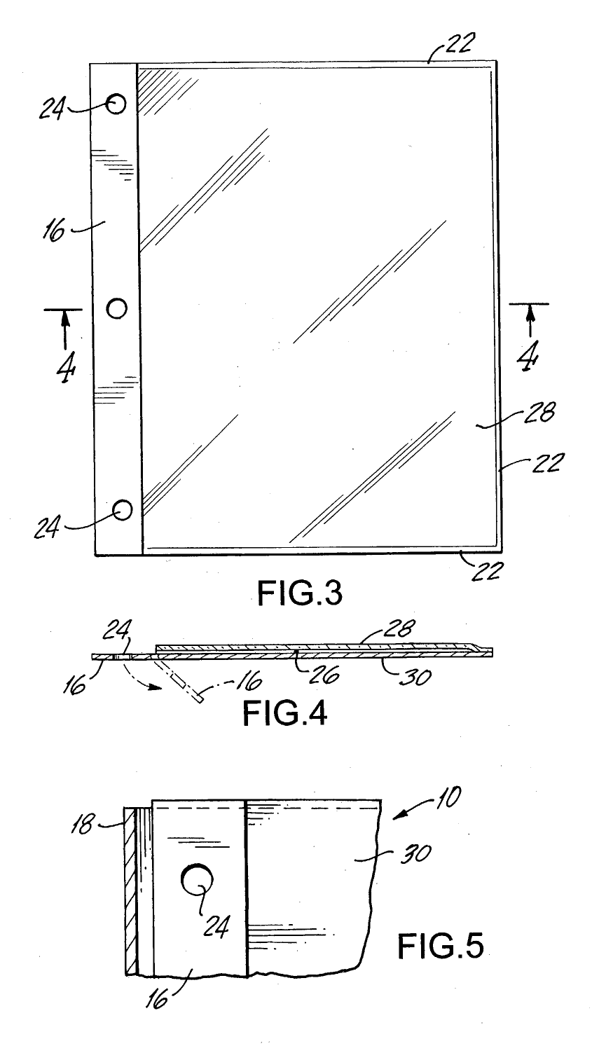

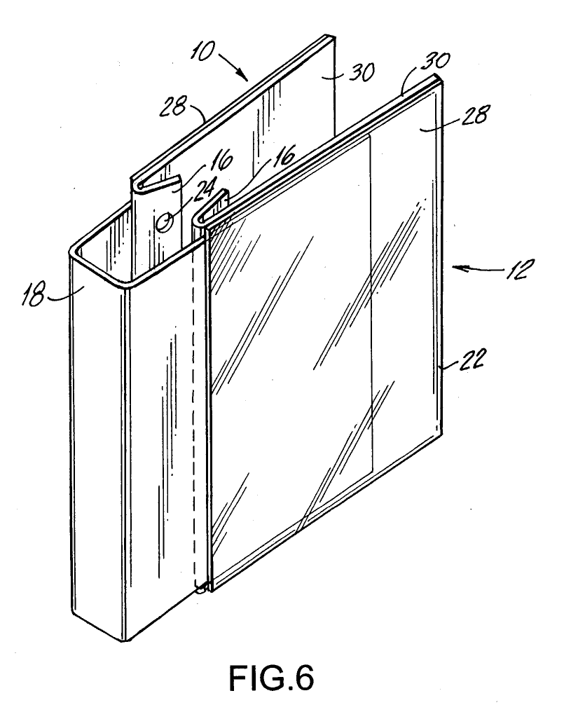

### DESCRIPTION OF THE PREFERRED EMBODIMENTS

The FIGS. illustrate a single, and presently preferred, embodiment of this invention. As shown therein, a front cover 10 and back cover 12, which are preferably structurally identical, are spaced from one another to encompass a document 14 between the two covers. Each cover 10 has a spine edge 20 and a front edge 22.

A flap 16 is attached to the spine edge 20 of each cover. The flap 16 is folded to be adjacent to the inside surface of each cover 10. In the embodiments shown, each flap 16 has openings 24 spaced to accept the prongs of a standard flexible prong paper fastener. The prong paper fastener binds each of the covers 10, 12 to the document 14 through the flaps 16. These openings 24 constitute a fastener mechanism and are preferably spaced to accept and work with a standard adjustable prong paper fastener.

The outside of each of the covers 10, 12 is a pocket 26 having a transparent sheet 28 fastened to the main cover sheet 30. The sheets 28 and 30 are attached to one another along three edges, preferably by a heat seal, and are open along the spine edge 20.

A spine cover 18 which can be made of paperboard or other heavy gage sheet can be bent to fit over the spine of the document 14 and slip into the open edges of the pockets 26.

In one embodiment, a pre-bent spine cover 18 is provided. A pre-bent spine can have creases at every 0.25 inches, for example, to facilitate use.

However, the user can bend the spine at any point to provide a simulated perfect binding as provided by a typical paperback book.

The length of the spine cover 18 is preferably selected to provide a slip fit relationship with the length of the pocket 26 into which portions of the spine will be inserted. This slip fit relationship (that is, one in which the length of the spine is nearly equal to the opening of the pocket 26) causes the spine to be held in place so that the spine can only be removed by a purposeful action of the user.

The pocket 26 on the front cover 10 is also adapted to receive a sheet which can be inserted therein to provide a cover designation and/or description for the document 14 contained therein.

A sheet can also be inserted in the pocket on the back cover 12 to provide either additional information or to cover the portion of the spine cover 18 contained therein.

Loose leaf sheets can constitute the document 14 that is normally held by the binder of this invention. However, the binder can also be used to hold a set of individually bound documents, such as a set of pamphlets, wherein the pages of each pamphlet are stapled together.

While the foregoing description and drawings represent the presently preferred embodiments of the invention, it should be understood that those skilled in the art will be able to make changes and modifications to those embodiments without departing from the teachings of the invention and the scope of the claims.

For example, although it is preferred that the outer sheet 28 of the pocket 26 be transparent, a non-transparent pocket sheet can be employed.

Although it is preferred that the pocket 26 and its open edge extend the full length of the spine, it is possible that a pocket 26 can be provided that extends less than the entire length of the spine.

In the preferred embodiment of this invention which is disclosed herein, a significant feature is that the dimensions of the cover and the dimensions of the loose leaf papers are essentially the same. The result is to provide a product which simulates the appearance of the paperback or soft cover book when closed and provides such an appearance either when shelved or placed closed on a table surface.

In a preferred design, the cover dimensions are substantially the same as the dimensions of the report bound therein so as to provide a rectangular effect. The heat sealing at the edges of the envelope may require a 1/64th inch additional extension of the cover. But as a practical matter, from the point of view of visual effect and from the point of view of stacking the reports on a shelf, the amount required to obtain the heat seal has no significant effect.

1. A loose leaf binder adapted to hold a variable thickness document comprising:
a front cover having a length, a width, a spine edge and a front edge,
a back cover having a length, a width, a spine edge and a front edge,
said covers being detachable from one another,
each of said covers having a pocket with an outer surface and an exterior open edge of said pocket substantially along said spine edge of said covers,
a fastener mechanism associated with said spine edges of said front and back covers to permit a variable thickness document to be fastened between said covers,
said pocket open edges being positioned and adapted to receive and hold first and second portion of a spine cover that may be fitted over the spine of whatever document is bound therein, and
an interior flap on said spine edge of each of said covers, said flap having fastener openings,
whereby
a variable length fastener may be employed to bind said covers to a document through said flap openings.

2. (canceled).

3. The binder of claim 1 wherein: said pocket open edge is substantially adjacent to said spine edge of each of said covers.

4. (canceled).

5. The binder of claim 1 wherein: at least said outer surface of said pocket on at least one of said covers is transparent to permit insertion of a cover sheet visible from the exterior of whatever document is bound therein.

6. (canceled).

7. The binder of claim 3 wherein: at least said outer surface of said pocket on at least one of said covers is transparent to permit insertion of a cover sheet visible from the exterior of whatever document is bound therein.

8. (canceled).

9. The binder of claim 1 wherein: at least said pocket on said front cover extends said length and width of said front cover.

10. The binder of claim 1 wherein: at least said pocket on said back cover extends said length and width of said back cover.

11. The binder of claim 3 wherein: at least said pocket on said front cover extends substantially said length and width of said front cover.

12. The binder of claim 3 wherein: at least said pocket on said back cover extends substantially said length and width of said back cover.

13. The binder of claim 7 wherein: at least said pocket on said front cover extends substantially said length and width of said front cover.

14. The binder of claim 7 wherein: at least said pocket on said back cover extends substantially said length and width of said back cover.

15. The binder of claim 1 wherein: said length and width dimensions of said covers are substantially equal to the dimensions of the document with which it is to be employed

16. (canceled).

17. The binder of claim 3 wherein: said length and width dimensions of said covers are substantially equal to the dimensions of the document with which it is to be employed.

18. The binder of claim 7 wherein: said length and width dimensions of said covers are substantially equal to the dimensions of the document with which it is to be employed.

19. The binder of claim 1 further comprising: a foldable spine sheet adapted to be folded at user determined vertical lines to provide a center segment for covering the spine and providing indicia thereon and first and second side segments to slip into said pockets of said covers.

20. The binder of claim 3 further comprising: a foldable spine sheet adapted to be folded at user determined vertical lines to provide a center segment for covering the spine and providing indicia thereon and first and second side segments to slip into said pockets of said covers.

21. The binder of claim 5 further comprising: a foldable spine sheet adapted to be folded at user determined vertical lines to provide a center segment for covering the spine and providing indicia thereon and first and second side segments to slip into said pockets of said covers.
